(19) United States
(12) Patent Application Publication
(10) Pub. No.: US 2014/0255617 A1
(43) Pub. Date: Sep. 11, 2014

(54) METHOD FOR FORMING COATING FILM ON PISTON OF INTERNAL COMBUSTION ENGINE AND COATING FILM FORMING APPARATUS

(71) Applicant: Hitachi Automotive Systems, Ltd., Hitachinaka-shi (JP)

(72) Inventor: Masato SASAKI, Sagamihara-shi (JP)

(73) Assignee: Hitachi Automotive Systems, Ltd., Hitachinaka-shi (JP)

(21) Appl. No.: 14/201,094

(22) Filed: Mar. 7, 2014

(30) Foreign Application Priority Data
Mar. 8, 2013 (JP) 2013-046415

(51) Int. Cl. F02F 3/10

(52) U.S. Cl. CPC F02F 3/10
USPC 427/554; 118/620

(57) ABSTRACT

Disclosed is a method for forming a double-layer, solid lubricant coating film on an external surface of a skirt portion of a piston in an internal combustion engine. This method includes the steps of (a) applying on the external surface of the skirt portion a solid lubricant composition containing a dark-color component, thereby forming thereon a precursor film; and (b) solidifying the precursor film by an irradiation with a laser beam from a laser oscillator, while moving at least one of the piston and the laser oscillator. It is possible by this method to form the double-layer, solid lubricant coating film with an extremely short period of time.

### TECHNICAL FIELD

The present invention relates to a method for forming a double-layer solid lubricant coating film on the surface of a skirt portion of a piston of internal combustion engines and an apparatus for forming the coating film.

### BACKGROUND OF THE INVENTION

As is generally known, various techniques have been proposed for improving wear resistance and seize resistance by forming a double-layer solid lubricant coating film on the surface of sliding members, such as a skirt portion of pistons of automotive internal combustion engines.

Japanese Patent Application Publication No. 2010-216362, corresponding to U.S. Pat. No. 8,220,433, discloses a technique, in which a solid lubrication coating film that is less susceptible to wear is formed as an inner layer, and a solid lubrication coating film that is more susceptible to wear is formed as an outer layer on the inner layer, thereby reducing unevenness (depth) of streaks remaining on the surface of a skirt portion of a piston to lower the friction between the skirt portion and a cylinder wall surface.

### SUMMARY OF THE INVENTION

In order to form a double-layer solid lubrication coating film like the technique described in Japanese Patent Application Publication No. 2010-216362, it is necessary to repeat treatments, such as drying and baking, for forming solid lubrication coating layers. As a result, it is necessary to have a long treatment time in total for forming a double-layer solid lubrication coating film. This makes the production operation cumbersome and causes an adverse effect on the production cost.

It is therefore an object of the present invention to provide a method and an apparatus for forming a double-layer solid lubrication coating film in a time as short as possible.

According to the present invention, there is provided a method for forming a double-layer, solid lubricant coating film on an external surface of a skirt portion of a piston of an internal combustion engine. This method includes the steps of:

(a) applying on the external surface of the skirt portion a solid lubricant composition containing a dark-color component, thereby forming thereon a precursor film; and

(b) solidifying the precursor film by an irradiation with a laser beam from a laser oscillator, while moving at least one of the piston and the laser oscillator.

### Advantageous Effect of the Invention

According to the present invention, it is possible to form a double-layer solid lubrication coating film with a short period of time in terms of the treatment time of the coating film formation step as a whole.

### BRIEF DESCRIPTION OF THE DRAWINGS

FIG. 1 is a half, vertical sectional view of a piston of an internal combustion engine that has been prepared in accordance with the present invention by forming a double-layer solid lubrication coating film on a skirt portion of the piston;

FIG. 2 is a front, partially sectional view of the piston in a sliding movement against a cylinder wall surface;

FIG. 3 is an enlarged schematic sectional view showing the double-layer solid lubrication coating film having inner and outer solid lubrication coating layers;

FIG. 4 is a characteristic diagram showing test results on the relationship between the content of a solid lubricant in the inner or outer coating layer and the strength of adhesion;

FIG. 5 is a flow chart showing a method for forming a double-layer coating film according to the present invention;

FIG. 6 is similar to FIG. 5, but showing a flow chart according to a conventional technique;

FIG. 7 is a schematic perspective view showing an apparatus for irradiating the inner coating layer with laser beams in accordance with a first embodiment of the present invention;

FIG. 8 is a schematic view showing a laser irradiation pattern in terms of energy density of the laser beams on six regions of the surface of the inner coating layer;

FIG. 9 is a graph showing test results on the relationship between the content of the solid lubricant composition shown by the index of “(G+B)+0.46×M” and the drying or baking time;

FIG. 10 is a graph showing test results on the relationship between the output energy density of the laser beams and the endpoint temperature of the inner coating layer;

FIG. 11 is a view similar to FIG. 7, but showing an apparatus according to a second embodiment of the present invention; and

FIG. 12 is a view similar to FIG. 7, but showing an apparatus according to a third embodiment of the present invention.

### DETAILED DESCRIPTION

In the following, there is described in detail with reference to the drawings an embodiment of a method for forming a double-layer, solid lubricant coating film on a piston of an internal combustion engine in accordance with the present invention. The piston in this embodiment is for use in a four-cycle gasoline engine.

As shown in FIG. 2, the piston 1 is slidably mounted on a cylinder block 2 of the engine and connected to a crankshaft of the engine by a piston pin 5 and a connecting rod 6 so as to slide against a substantially cylindrical cylinder wall surface 3 of the cylinder block 2 and to cause a rotational movement of the crankshaft by the reciprocating sliding motion of the piston 1.

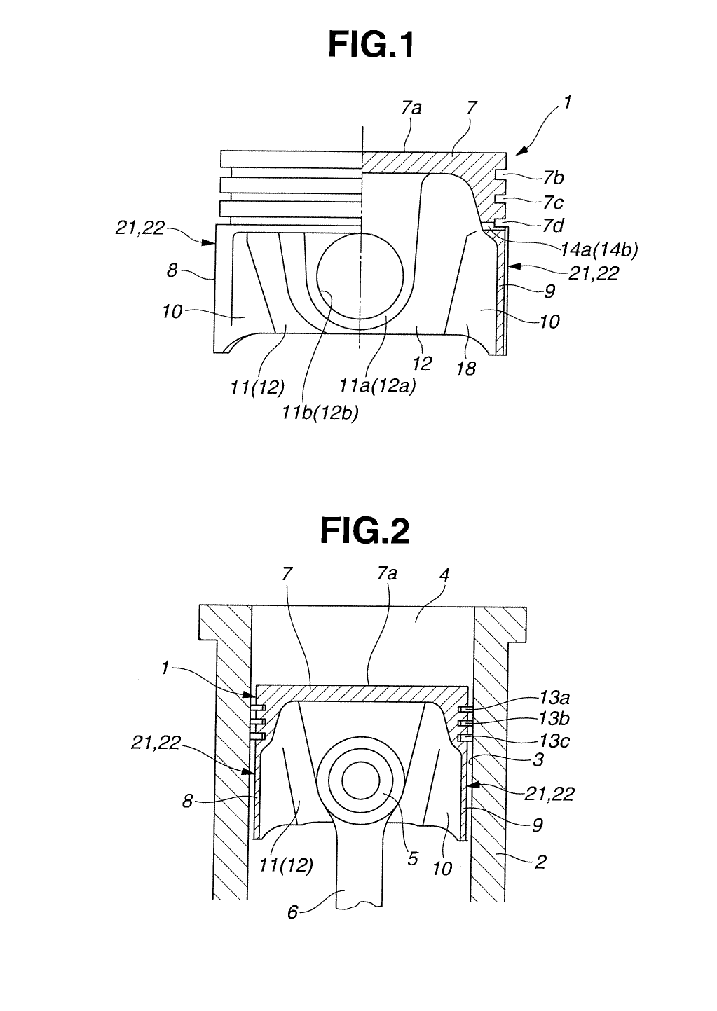

As shown in FIGS. 1, 2 and 7, the piston 1 has its body formed in one piece by forging of a base material such as aluminum alloy, e.g., A-Si alloy AC8A (Japanese Industrial Standard (JIS) H 5202) and includes a piston crown portion 7 (also called a “piston head portion”), a pair of thrust-side and counterthrust-side piston skirt portions 8, 9, and a pair of piston apron portions 11, 12. The piston apron portions 11, 12 are connected to circumferentially opposite sides of the piston skirt portions 8, 9 by connection parts 10, respectively.

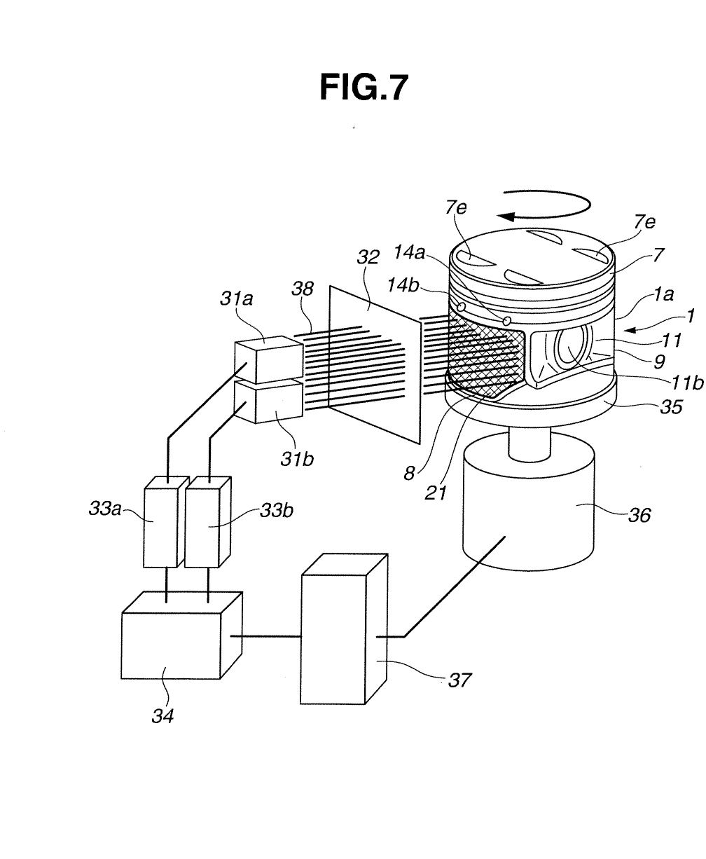

The piston crown portion 7 has a substantially cylindrical (disc) shape with a relatively large thickness. There is a combustion chamber 4 defined by a cylinder head of the engine, a top surface 7a of the piston crown portion 7 and the cylinder wall surface 3. A valve recess 7e (see FIG. 7) is formed in the top surface 7a of the piston crown portion 7 to avoid interference with engine intake and exhaust valves. Furthermore, ring grooves 7b, 7c, 7d are formed in an outer circumferential surface of the piston crown portion 7 to hold therein three piston rings 13a, 13b, 13c, such as pressure ring, oil ring, etc.

Each skirt portion 8, 9 has two drain holes 14a and 14b, which are formed therethrough on a bottom wall of the oil ring groove 7d, for discharging a lubricant collected in the oil ring groove 7d by scraping of the oil ring 13c against the cylinder wall surface 3, into an inner space of the piston 1. The apron portions 11 and 12 have holes 11b and 12b formed therethrough, for holding the piston pin 5 by pin bosses 11a, 12a.

The piston skirt portions 8, 9 are formed integrally with a bottom edge of the piston crown portion 7 and located symmetrical with respect to the axis of the piston 1. Each of the piston skirt portions 8, 9 has a substantially arc-shaped cross section with a relatively small thickness throughout almost its entirety. The thrust-side piston skirt portion 8 is adapted to, when the piston 1 moves down to the bottom dead center (BDC) during an expansion stroke, incline toward and come in contact under pressure with a thrust side of the cylinder wall surface 3 due to the angular positional relationship of the piston 1 and the connecting rod 6. On the other hand, the counterthrust-side piston skirt portion 9 is adapted to, when the piston moves up to the top dead center (TDC) during a compression stroke, incline toward and come in contact under pressure with a counterthrust side of the cylinder wall surface 3. As the thrust-side piston skirt portion 8 is in sliding contact with the cylinder wall surface 3 under the influence of a combustion pressure, the contact pressure load of the thrust-side piston skirt portion 8 on the cylinder wall surface 3 is larger than that of the counterthrust-side piston skirt portion 9 on the cylinder wall surface 3.

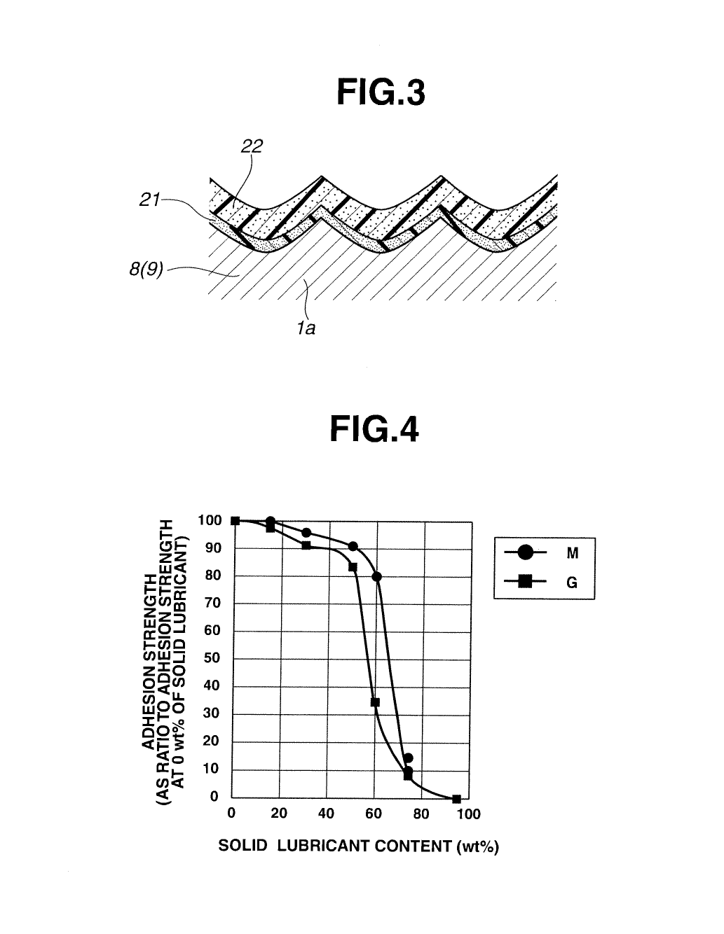

As shown in FIGS. 1 and 3, a double-layer solid lubricant film is formed on the thrust-side skirt portion 8 and the counterthrust-side skirt portion 9 of the piston 1.

That is, this double-layer solid lubricant film has an inner (lower) coating layer (a first solid lubricant film) 21, which is formed on the surface of the piston base member 1a, and an outer (upper) coating layer (a second solid lubricant film) 22, which is formed on the surface of the inner coating layer 21, for sliding against the cylinder wall surface 3. The inner and outer coating layers 21, 22 each contain as a binder resin at least one of epoxy resins, polyimide resins, and polyamide-imide resins, which are superior in heat resistance, wear resistance and adhesion.

Specifically, the outer coating layer 22 may contain 5-50 wt % of the binder resin and 50-95 wt % of a solid lubricant (i.e., at least one of molybdenum disulfur (M) and graphite (G)), based on the total weight (100 wt %) of the binder resin and the solid lubricant.

If the content of the binder resin is less than 5 wt % in the outer coating layer 22, its adhesion to the inner coating layer 21 may become inferior. If it is greater than 50 wt %, the content of the solid lubricant may become too low. With this, the initial adaptability of the piston 1 to the cylinder wall surface 3 may become inferior.

The inner coating layer 21 may contain 50 wt or more of the binder resin and 50 wt % or less of a solid lubricant (i.e., at least one of molybdenum disulfur (M), graphite (G), carbon black (B), boron nitride, and a metal powder of iron alloy, aluminum alloy, etc.), based on the total weight (100 wt %) of the binder resin and the solid lubricant.

If the content of the binder resin is less than 50 wt % in the inner coating layer 21, adhesion of the inner coating layer 21 to the piston base member 1a may become inferior. In connection with this, FIG. 4 shows the change of adhesion of the outer or inner coating layer 22, 21 by adding its solid lubricant (e.g., graphite (G) and/or molybdenum disulfur (M)) to the binder resin. In fact, it is understood from FIG. 4 that adhesion is drastically decreased as the content of the solid lubricant exceeds 50 wt %, that is, as the content of the binder resin becomes less than 50 wt %.

Thus, the inner coating layer 21 has a function of securing adhesion to the piston base member 1a and adhesion to the outer coating layer 22.

Therefore, the inner coating layer 21 is not required to contain a large amount of the solid lubricant, but it is allowed to add the solid lubricant in the preparation of the inner coating layer 21 to the extent that adhesion is secured, thereby improving characteristics of the inner coating layer 21.

In the inner coating layer 21, when the content of the molybdenum disulfur (M) as the solid lubricant is less than 5 wt %, seize resistance may become inferior. If it is greater than 20 wt %, the strength of the coating film may become too low. With this, wear of the coating film may become too much.

Furthermore, the inner coating layer 21 can be improved in seize resistance by a synergy effect between molybdenum disulfur (M) and graphite (G) as the solid lubricant.

Therefore, it is possible to use both of molybdenum disulfur (M) and graphite (G) together as the solid lubricant in the preparation of the inner coating layer 21. In this case, it is preferable for the inner coating layer 21 that the total content of molybdenum disulfur (M) and graphite (G) is 5 to 20 wt %, and that the content of molybdenum disulfur is 1 to 10 wt %.

The reason of this is that it may be difficult to sufficiently improve seize resistance by the synergy effect, if molybdenum disulfur (M) is less than 1 wt %, and that wear resistance may become too low, if it is greater than 10 wt %.

As mentioned above, the outer coating layer 22 may contain 50-95 wt % of the solid lubricant (i.e., at least one of molybdenum disulfur (M) and graphite (G)). If it is less than 50 wt %, the initial adaptability may become too low. If it is greater than 95 wt %, the content of the binder resin becomes less than 5 wt %. With this, as mentioned above, its adhesion to the inner coating layer 21 may become too low.

Each of the outer and inner coating layers 22, 21 may be prepared, for example, by a method in which an organic solvent is mixed with the binder resin (i.e., at least one of epoxy resins, polyimide resins, and polyamide-imide resins) to prepare a resin solution, then the solid lubricant is added to the resin solution, then according to need hard particles are added, and then the mixture is milled by a bead mill or the like to obtain a solid lubricant composition.

As mentioned above, the contents by weight % of the binder resin and the solid lubricant (e.g., molybdenum disulfur (M) and graphite (G)) are arranged, based on the total (100 wt %) of these.

According to need, the solid lubricant composition may be diluted with an organic solvent. The resulting coating solution may be applied onto the piston base member 1a.

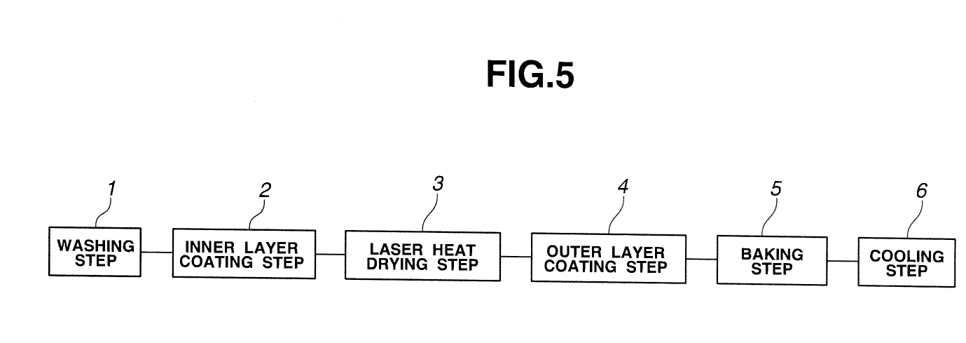

For example, as shown in FIG. 5, the coating solution for the inner coating layer 21 is applied onto the external circumferential surfaces of the thrust-side skirt portion and the counterthrust-side skirt portion of the piston base member 1a, followed by drying for cure. Then, the coating solution for the outer coating layer 22 is applied onto the inner coating layer cured, followed by baking for cure. With this, a double-layer solid lubricant coating film is obtained.

The above-mentioned organic solvent used for the dilution is not particularly limited, as long as it can dissolve the binder resin.

The baking conditions, such as baking temperature and baking time, may suitably be set. Since the baking can be conducted at a temperature of 200° C. or lower, the solid lubricant coating film may be formed on the piston 1 even if it is made of an aluminum alloy, which is relatively weak in heat resistance.

The thickness of each of the inner and outer coating layers 21, 22 may suitably be set. It is preferably around 5-40 μm, in view of operability, cost, etc. of the application of the composition.

### First Embodiment

### Method for Forming the Solid Lubricant Coating Film

With reference to FIG. 5, there is explained a method for forming the inner coating layer 21 and the outer coating layer 22 on the surface of the skirt portions 8, 9 of the piston base member 1a, as follows.

Firstly, the surface of the piston base member 1a is subjected to a pretreatment, such as solvent degreasing and alkali degreasing, to remove oils and stains (Washing Step 1).

Then, the surface of the piston base member 1a is coated with the inner coating layer 21 by a known method, such as screen printing (Inner Layer Coating Step 2) using, for example, a mechanism for applying on the external surface of the skirt portion a solid lubricant composition containing at least one selected from graphite (G), carbon black (B), molybdenum disulfur (M), boron nitride, and a metal powder.

Then, the inner coating layer (i.e., a precursor film of the inner coating layer) 21 is dried by heating. In this drying step, drying is conducted by heating by a laser light using a laser heating apparatus (see e.g., FIG. 7) to remove the organic solvent (Laser Heat Drying Step 3).

Then, the surface of the inner coating layer 21 is coated with the outer coating layer 22 by a similar known method, such as screen printing (Outer Layer Coating Step 4).

Then, the outer coating layer 22 is subjected, for example, to a drying/baking treatment by using a known apparatus, such as a continuous heating furnace, under conditions of 180° C. for 30 minutes or 200° C. for 20 minutes (Baking Step 5). Alternatively, it is optional to repeat the above-mentioned laser heat drying to dry the outer coating layer 22.

Then, the piston base member 1a with the inner coating layer 21 and the outer coating layer 22 as a whole is cooled by a cooling apparatus (Cooling Step 6).

With this, the steps for forming the inner coating layer 21 and the outer coating layer 22 in series are completed.

In this embodiment of the present invention, the drying step of the inner coating layer 21 is conducted by a laser light using the laser heating apparatus (see FIG. 7). In contrast, according to conventional techniques, this drying has been conducted, for example, by using a continuous heating furnace, not by using a laser light as in the present invention.

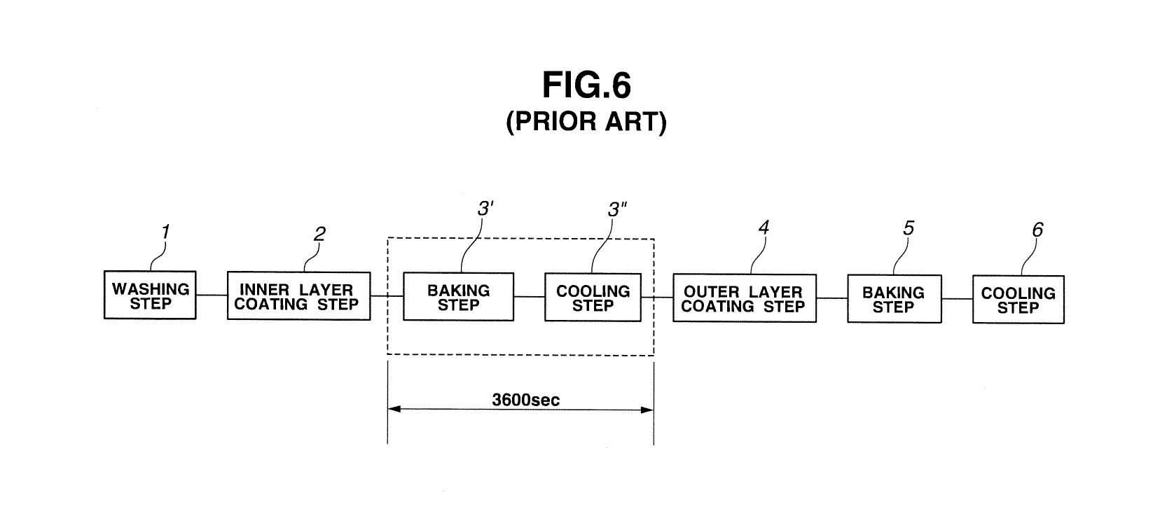

In fact, according to conventional techniques, as shown in FIG. 6, Washing Step 1, Inner Layer Coating Step 2, Outer Layer Coating Step 4, Baking Step 5, and Cooling Step 6 are conducted in the same manner as those of the present embodiment. In conventional techniques, however, the drying step for drying the inner coating layer 21 has been conducted by a drying/baking treatment using, for example, a continuous heating furnace (Baking Step 3′), followed by cooling the piston base member 1a with the inner coating layer 21 as a whole by a cooling apparatus (Cooling Step 3″). It has been necessary in conventional techniques to spend a long period of time of about 3,600 seconds, that is, about one hour, in total, for conducting Baking Step 3′ and Cooling Step 3″ of FIG. 6.

In contrast, in the present invention, a continuous heating furnace, an infrared heating apparatus, or the like of conventional techniques is not used, but a laser heating apparatus as shown in FIG. 7, 11 or 12 is used for drying the inner coating layer 21. Therefore, it is possible to conduct the drying step in an extremely short period of time of about 10 seconds.

As specifically explained, the laser heating apparatus as shown in FIG. 7 is constituted mainly of (a) two laser oscillators 31a, 31b vertically arranged in parallel, (b) a glass-made, diffusion panel 32 interposed between the laser oscillators 31a, 31b and the piston base member 1a, (c) two laser power sources 33a, 33b for respectively supplying currents to the laser oscillators 31a, 31b, (d) an output control panel 34 for controlling the current values from the laser power sources 33a, 33b, (e) a support member 35 for supporting thereon the piston base member 1a, (f) a stepping motor 36 for rotating the support member 35, and (g) a control unit 37 for synchronizing the rotation control by the stepping motor 36 with the output control by the output control panel 34.

The laser oscillators 31a, 31b are each formed by stacking a plurality of laser diode bars and each adjusted so that parallel laser beams 38 of a single bundle are applied in a diametral direction of the piston base member 1a onto the inner coating layer 21 formed on the curved external surfaces of the skirt portions 8, 9.

Each laser oscillator 31a, 31b receives from each laser power source 33a, 33b an electric current controlled by the output control panel 34 through the control unit 37 and emits parallel laser beams 38 of a single bundle against inner coating layer 21 in a diametral direction of the piston base member 1a.

The glass-made, diffusion panel 32 scatters the laser beams 38 at a suitable degree to make the energy density more uniform on the inner coating layer 21 as a whole.

The piston base member 1a is controlled to rotate in clockwise direction (the direction of the arrow in FIG. 7) about an axis of the piston 1 by the stepping motor 36 through the support member 35.

The rotation speed of the stepping motor 36 is controlled by a pulse current from the control unit 37. With this, the emission of the laser beams 38 from each laser oscillator 31a, 31b is controlled to become uniform on the inner coating layer 21 as a whole.

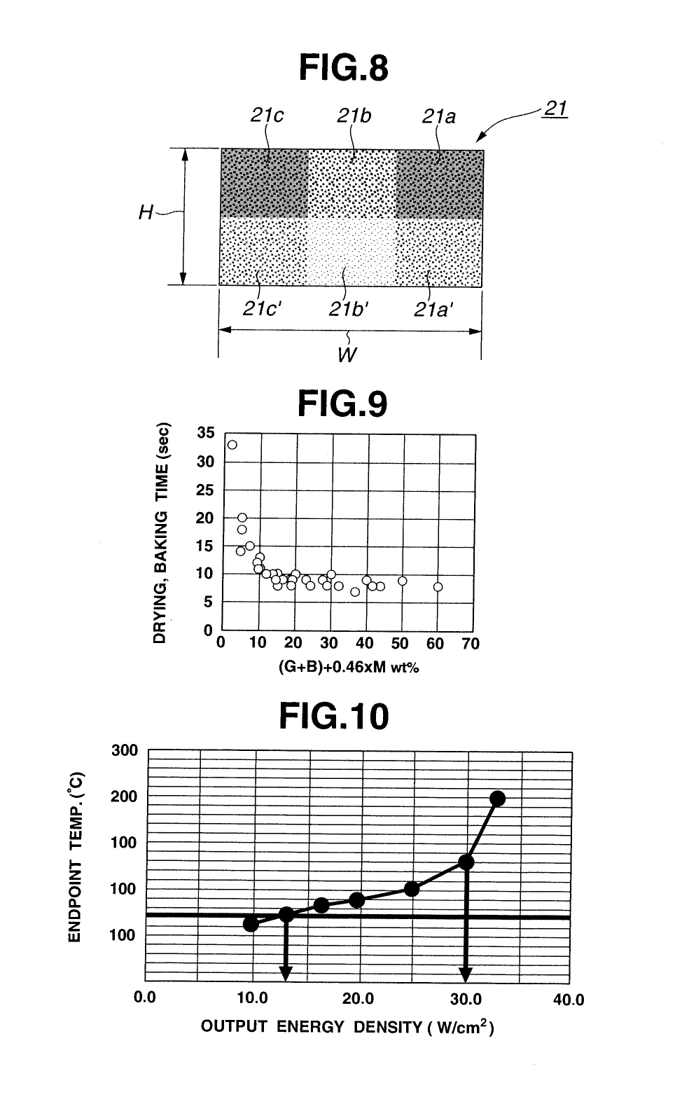

As shown in FIG. 8, the entire major surface of the inner coating layer 21 as the target in the emission of the laser beams 38 may be divided into six regions in terms of the output energy density of the laser beams 38. In fact, left and right regions 21c, 21c′, 21a, and 21a′ are respectively set to be higher than central regions 21b and 21b′ in terms of the output energy density of the laser beams 38 on the inner coating layer 21. In other words, since heat radiation from the piston base member 1a made of an aluminum alloy is relatively high in the left and right regions 21c, 21c′, 21a, and 21a′, the energy density of the laser beams 38 from the two laser oscillators 31a, 31b is set to be relatively high. In contrast, since heat radiation from the piston base member 1a is relatively low in the central regions 21b and 21b′, the energy density of the laser beams 38 from the two laser oscillators 31a, 31b is set to be relatively low. These two settings are conducted to make the heating temperature on the entire surface of the inner coating layer 21 uniform.

Furthermore, since heat radiation from the crown portion 7 of the piston 1 is relatively high, the energy density of the laser beams 38 is set to higher in the upper regions 21a to 21c, as compared with the lower regions 21a′ to 21c′. Thus, the energy density is set to be highest in the upper left and upper right regions 21a and 21a as shown by a dark color in FIG. 8. The second highest energy density is set in the upper central region 21b.

The third highest energy density is set in the lower left and lower right regions 21c′ and 21a′ and to be slightly higher than the fourth highest energy density in the lower central region 21b′ shown by a light color in FIG. 8.

By setting the first to fourth highest energy densities in the six regions of the inner coating layer 21 as mentioned above, it becomes possible to make the energy density of the laser beams 38 uniform on the entire surface of the inner coating layer 21. In other words, it is possible to uniformly heat the inner coating layer 21 in its entirety for drying.

Specifically, at first, the laser beams 38 are emitted from the laser oscillators 31a, 31b against the left regions 21c, 21c′ of the inner coating layer 21 at predetermined laser outputs for a predetermined period of time. Then, the piston base member 1a is rotated by a predetermined rotation angle by the stepping motor 36 in the direction of the arrow in FIG. 7. After that, the laser beams 38 are emitted from the laser oscillators 31a, 31b against the central regions 21b, 21b′ of the inner coating layer 21 at predetermined laser outputs for a predetermined period of time. Then, the piston base member 1a is rotated as mentioned above. After that, the laser beams 38 are emitted against the right regions 21a, 21a′ in a similar manner against the left regions 21c, 21c′. With this, it becomes possible to make the energy density of the laser beams 38 uniform on the entire surface of the inner coating layer 21 to uniformly heat and dry the inner coating layer 21.

Suppose that the value of the highest energy density of the laser beams 38 against the upper left and right regions 21c, 21a is set at 100 as an absolute number, the second highest one against the upper central region 21b may be 50-80, the third highest one against the lower left and right regions 21c′, 21a′ may be 30-60, and the fourth highest one against the lower central region 21b′ may be 20-50.

It is also possible to automatically change the outputs of the laser oscillators 31a, 31b by the output control panel 34 depending on the rotation position of the piston base member 1a, while the piston base member 1a is continuously rotated.

As shown in Table 1, test samples Nos. 1 to 34 as inner coating layers 21 were formed by applying coating compositions prepared by mixing a black-color, solid lubricant (i.e., graphite (G), carbon black (B), and/or molybdenum disulfur (M)), a polyamide-imide as the binder resin, and 30-70 wt % of N-methylpyrrolidone as a solvent. Using the laser heating apparatus (see FIG. 7) of the invention, these test samples Nos. 1 to 34 were irradiated with laser beams 38 having an energy density of 30 W/cm². In this irradiation, the period of time in seconds for drying each sample was measured. The results of this drying time are shown in Table 1.

TABLE 1

| | Graphite | Carbon | Molybdenum | | Drying time | |
|---|---|---|---|---|---|---|
| | (G) | black (B) | disulfur (M) | Polyamideimide | (sec.) | (G + B) + 0.46 × M |
| No. | (wt %) | (wt %) | (wt %) | (wt %) | 30 W/cm² | (wt %) |
| 1 | 0 | 0 | 0 | 100 | — | 0 |
| 2 | 5 | 0 | 0 | 95 | 18 | 5 |
| 3 | 10 | 0 | 0 | 90 | 13 | 10 |
| 4 | 15 | 0 | 0 | 85 | 10 | 15 |
| 5 | 20 | 0 | 0 | 80 | 10 | 20 |
| 6 | 30 | 0 | 0 | 70 | 10 | 30 |
| 7 | 40 | 0 | 0 | 60 | 9 | 40 |
| 8 | 50 | 0 | 0 | 50 | 9 | 50 |
| 9 | 60 | 0 | 0 | 40 | 8 | 60 |
| 10 | 0 | 2 | 0 | 98 | 33 | 2 |
| 11 | 0 | 5 | 0 | 95 | 20 | 5 |
| 12 | 0 | 10 | 0 | 90 | 11 | 10 |
| 13 | 0 | 15 | 0 | 85 | 8 | 15 |
| 14 | 0 | 20 | 0 | 80 | 10 | 20 |
| 15 | 0 | 0 | 10 | 90 | 14 | 5 |
| 16 | 0 | 0 | 20 | 80 | 12 | 9 |
| 17 | 0 | 0 | 30 | 70 | 10 | 14 |
| 18 | 0 | 0 | 40 | 60 | 9 | 18 |
| 19 | 0 | 0 | 50 | 50 | 9 | 23 |
| 20 | 0 | 0 | 60 | 40 | 9 | 28 |
| 21 | 0 | 0 | 70 | 30 | 8 | 32 |
| 22 | 0 | 0 | 80 | 20 | 7 | 37 |
| 23 | 0 | 0 | 90 | 10 | 8 | 41 |
| 24 | 0 | 0 | 95 | 5 | 8 | 44 |
| 25 | 15 | 0 | 30 | 55 | 8 | 29 |
| 26 | 5 | 0 | 30 | 65 | 8 | 19 |
| 27 | 15 | 0 | 20 | 65 | 8 | 24 |
| 28 | 10 | 0 | 20 | 70 | 9 | 19 |
| 29 | 5 | 0 | 25 | 70 | 9 | 17 |
| 30 | 10 | 0 | 10 | 80 | 9 | 15 |
| 31 | 5 | 0 | 15 | 80 | 10 | 12 |
| 32 | 5 | 0 | 10 | 85 | 12 | 10 |
| 33 | 5 | 0 | 5 | 90 | 15 | 7 |
| 34 | 0 | 5 | 10 | 85 | 11 | 10 |

As shown in Table 1, the test sample No. 1 was prepared by using no solid lubricant. In this case, the inner coating layer 21 was not dried by the laser irradiation.

The results of the test samples Nos. 2 and 3 were inferior, since the drying time was longer than 10 seconds.

The results of the test samples Nos. 10-12 were also inferior, since it was longer than 10 seconds.

The test sample No. 9 as a single layer was insufficient in terms of adhesion to the piston base member 1a. Similarly, the test samples Nos. 19-24 as single layers were insufficient in terms of adhesion to the piston base member 1a, but were judged to be usable as outer coating layers 22.

The test samples Nos. 15 and 16 were also inferior, since it was longer than 10 seconds.

The test samples Nos. 32 to 34 were also inferior, since it was longer than 10 seconds.

In contrast, the test samples Nos. 4-9, 13-14 and 17-31 were superior, since it was not longer than 10 seconds.

The laser beams 38 are absorbed by a black-color component (e.g., graphite (G), molybdenum disulfur (M), and carbon black (B)), and thereby the black-color component generates heat to dry the inner coating layer 21.

Absorption of the laser beams 38 increases, as the volume percentage of the black component in the inner coating layer 21 becomes larger. However, as this volume percentage exceeds a certain level, absorption of the laser beams 38 becomes constant. This is because the surface of the inner coating layer 21 is fully covered with the black component at the certain level.

For example, each of graphite (G) and carbon black (B) may have a density of 2.2, and molybdenum disulfur (M) may have a density of 4.8. In this case, the content by wt % of molybdenum disulfur (M) multiplied by 0.46 (2.2/4.8=0.46) becomes equivalent with that of graphite (G) or carbon black (B). Thus, it is possible to use the index of “G+B+0.46×M” (see Table 1) in terms of volume percentage of the solid lubricant. In this index, G, B and M respectively represent the contents of graphite, carbon black and molybdenum disulfur by wt %, based on the total (100 wt %) of the solid lubricant and the binder resin.

As shown in FIG. 9, the drying time becomes 10 seconds or shorter, if the index of “G+B+0.46×M” becomes 12 wt % or greater.

As mentioned above, if the index of “G+B+0.46×M” is greater than 50 wt %, the inner coating layer 21 becomes inferior in adhesion to the piston base member 1a (see test sample No. 9 in Table 1).

Therefore, it is possible to adjust the drying time to 10 seconds or shorter, if the index of “G+B+0.46×M” is from 12 to 50 wt %.

FIG. 10 is a graph showing test results on the relationship between the output energy density of the laser light and the endpoint temperature of the inner coating layer 21, when the inner coating layer 21 was irradiated with the laser beams 38.

In order to determine the output energy density of the laser beams 38 for drying the inner coating layer 21, the coating composition of the test sample No. 6 (containing 30 wt % of graphite (G) and 70 wt % of polyimide) was applied onto the surface of the skirt portion 8 of the piston base member 1a to have a film thickness of 30 μm. Then, the film was irradiated with the laser beams 38 at a certain output energy density for 10 seconds. During this irradiation, the surface temperature of the inner coating layer 21 was measured by a thermoviewer to determine the temperature rise rate (° C./seconds). This procedure was repeated by changing the output energy density of the laser beams 38. The results are shown in Table 2.

TABLE 2

| Temperature rise rate | Film condition after |
|---|---|
| (° C./sec.) | 10 seconds irradiation |
| 8.3 | Partly not dry |
| 9.5 | Partly not dry |
| 10.1 | Partly not dry |
| 11.3 | Dry |
| 12.2 | Dry |
| 12.3 | Dry |
| 13.3 | Dry |
| 13.9 | Dry |
| 15.1 | Dry |
| 16.1 | Dry |
| 17.2 | Dry |
| 18.5 | Dry |
| 19.5 | Dry |
| 20.5 | Dry |
| 21.3 | Dry |
| 22.7 | Dry |
| 23.9 | Dry |
| 24.8 | Bumping and burning risk |
| 26.1 | Bumping and burning risk |
| 27.3 | Bumping and burning risk |

As shown in Table 2, we have found that the film was completely and successfully dried by the 10 seconds laser irradiation by adjusting the temperature rise rate to 11.3-23.9° C./seconds, irrespectively of the thickness of the piston base member 1a.

As shown in Table 2, when the temperature rise rate was lower than 11.3° C./seconds, the film was partly not dry. When it was higher than 23.9° C./seconds, the solvent evaporated abruptly during the temperature rise step, thereby generating swelling of the inner coating layer 21. At last, there was a burning risk of the solvent. Thus, it was not possible to obtain a robust film as the inner coating layer 21.

Therefore, we have found that it is possible to suitably dry the inner coating layer 21 by the irradiation for 10 seconds with the laser beams 38, when the output energy density of the laser beams 38 is adjusted such that the temperature rise rate is in a range of 11.3-23.9° C./seconds.

As mentioned above, it is possible to suitably dry the inner coating layer 21 formed on each skirt portion 8, 9 of the piston base member 1a with an extremely short period of time of 10 seconds or shorter by using the laser heating apparatus of the present invention.

As a result, it becomes possible by the present invention to form a double-layer solid lubricant coating film with a shorter period of time than that of conventional techniques. With this, it is possible to improve the efficiency of the production operation and greatly reduce the production cost.

Furthermore, as mentioned above, the solid lubricant (e.g., graphite (G)) in the inner coating layer 21 is directly heated by the laser beams 38. With this, the temperature rise of the piston base member 1a itself is very limited. Therefore, it is not necessary to conduct cooling of the piston 1 after the drying and install a cooling apparatus. With this, it is possible to further shorten the period of time for forming a double-layer solid lubricant coating film and further reduce the production cost.

According to the present invention, the inner coating layer 21 is superior in adhesion to the piston base member 1a. Furthermore, the outer coating layer 22 is superior in terms of the initial adaptability to the cylinder wall surface 3 when the thrust-side and counterthrust-side piston skirt portions 8, 9 of the piston 1 slide against the cylinder wall surface, by containing 50-95 wt % of the solid lubricant (i.e., at least one of molybdenum disulfur (M) and graphite (G)). In other words, the surface of the outer coating layer 22 wears in a short period of time to quickly form a smooth sliding surface on the outer coating layer 22. This means that the initial adaptability against the cylinder wall surface 3 is superior.

### Second Embodiment

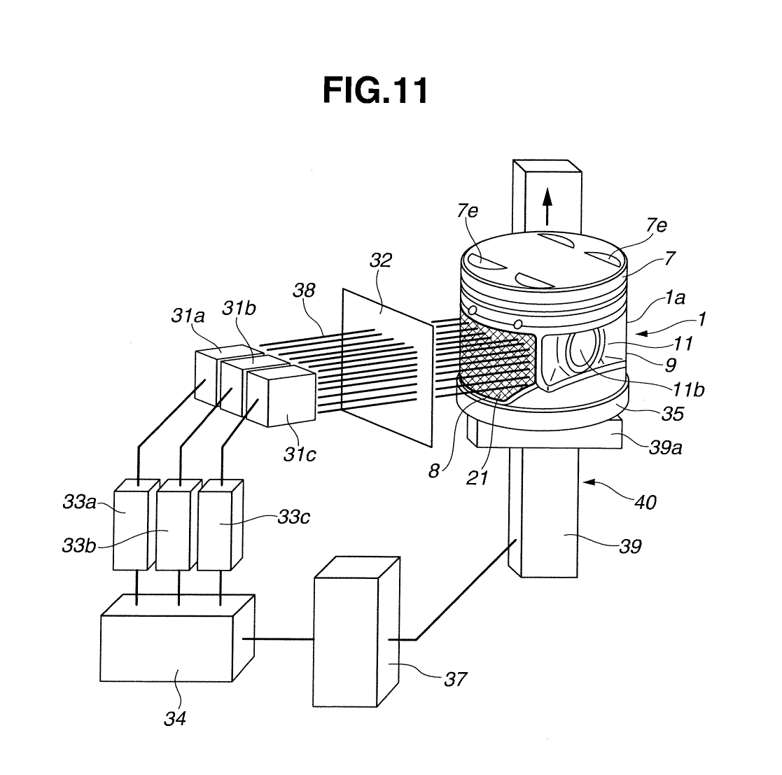

FIG. 11 shows a second embodiment of the present invention, in which the laser heating apparatus has three laser oscillators 31a, 31b, 31c, in which a glass-made, diffusion panel 32 is interposed between the laser oscillators 31a, 31b, 31c and the skirt portion 8, 9 of the piston base member 1a, and in which the piston base member 1a is made vertically movable by an elevator 40.

The laser heating apparatus as shown in FIG. 11 is constituted mainly of (a) three laser oscillators 31a, 31b, 31c horizontally arranged in parallel, (b) three laser power sources 33a, 33b, 33c for respectively supplying currents to the laser oscillators 31a, 31b, 31c, (c) an output control panel 34 for controlling the current values from the laser power sources 33a, 33b, 33c, (d) a support member 35 for supporting the piston base member 1a, (e) a linear guide 39 for linearly guiding the piston base member 1a in a vertical direction through a support portion 39a for supporting the support member 35, and (f) a control unit 37 for synchronizing the control of the vertical movement of the linear guide 39 with the output control by the output control panel 34.

The elevator 40 is constituted of (a) the linear guide 39, (b) an electric motor (not shown in the drawings) for driving the linear guide 39, and (c) a speed reducer (reduction gear) for slowing the rotation speed of the electric motor. Thus, the electric motor is controlled by the control current from the control unit 37 in terms of direction of the rotation and the rotation speed.

Each laser oscillator 31a, 31b, 31c of the second embodiment (FIG. 11) has a structure similar to that of the first embodiment (FIG. 7). Thus, each laser oscillator 31a, 31b, 31c receives from each laser power source 33a, 33b, 33c an electric current controlled by the output control panel 34 through the control unit 37 and emits parallel laser beams 38 of a single bundle against inner coating layer 21 in a diametral direction of the piston base member 1a.

The piston base member 1a is controlled to move by the elevator 40 through the support member 35 in the axial direction of the piston 1. The rotation speed of the electric motor of this elevator 40 is controlled by a pulse current from the control unit 37. With this, the irradiation of the inner coating layer 21 with the laser beams 38 from each laser oscillator 31a, 31b, 31c is controlled to become uniform on the inner coating layer 21 as a whole. In other words, it is possible to uniformly heat and dry the inner coating layer 21 as a whole.

As shown in FIG. 8, six regions of the surface of the inner coating layer 21 are irradiated with the laser beams 38 from the laser oscillators 31a, 31b, 31c in a way similar to that of the first embodiment. Specifically, the upper three regions 21a, 21b, 21c are firstly irradiated with the laser beams 38 with predetermined laser outputs for a predetermined period of time. Then, the piston base member 1a is moved upward to a predetermined position by the elevator 40. Then, the lower three regions 21a′, 21b′, 21c′ are irradiated with the laser beams 38 with predetermined laser outputs for a predetermined period of time.

With this, the irradiation of the inner coating layer 21 with the laser beams 38 from the laser oscillators 31a, 31b, 31c becomes uniform on the inner coating layer 21 as a whole. In other words, it is possible to uniformly heat and dry the inner coating layer 21 as a whole.

Therefore, it becomes possible to obtain advantageous effects similar to those of the first embodiment. Furthermore, it becomes possible to further shorten the drying time of the inner coating layer 21 by using the three laser oscillators 31a, 31b, 31c.

It is also possible to change the laser output of the laser oscillators 31a to 31c, depending on the vertical position of the piston base member 1a, by continuously moving the piston base member 1a in an upward direction by the elevator 40. Alternatively, it is also possible to irradiate the lower regions 21a′ to 21c′ and then the upper regions 21a to 21c stepwise or continuously by moving the piston base member 1a downward by the elevator 40.

### Third Embodiment

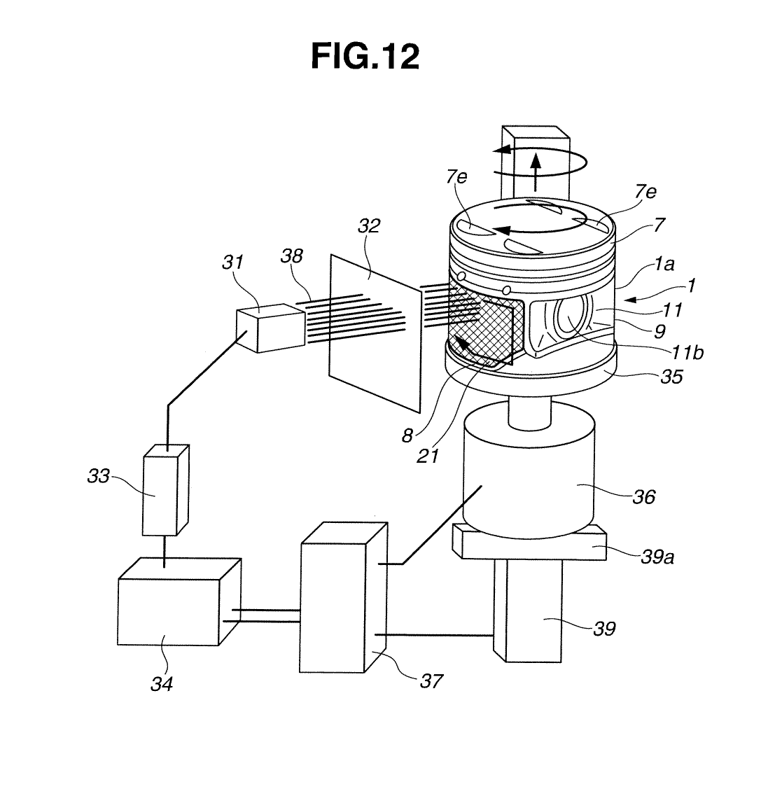

FIG. 12 shows a third embodiment of the present invention, in which the laser heating apparatus has a single oscillator 31 and a combination of the stepping motor 36 of the first embodiment and the elevator of the second embodiment so that the piston base member 1a is made to be rotatable about its axis and movable in a vertical direction.

The laser oscillator 31 of the third embodiment (FIG. 12) has a structure similar to that of the first embodiment (FIG. 7). Thus, the laser oscillator 31 receives from a laser power source 33 an electric current controlled by the output control panel 34 through the control unit 37 and emits parallel laser beams 38 of a single bundle against inner coating layer 21 in a diametral direction of the piston base member 1a.

The stepping motor 36 and the elevator 40 are also respectively similar to those of the first and second embodiments. Thus, the rotation speed of the stepping motor 36 is controlled by a pulse current from the control unit 37. With this, the emission of the laser beams 38 from the laser oscillator 31 is controlled to become uniform on the inner coating layer 21 as a whole.

The elevator 40 is constituted of (a) a linear guide 39 for moving in a vertical direction the stepping motor 36 fixed to the top surface of a support portion 39a, (b) an electric motor (not shown in the drawings) for driving the linear guide 39, and (c) a speed reducer (reduction gear) for slowing the rotation speed of the electric motor. Thus, the electric motor is controlled by the control current from the control unit 37 in terms of direction of the rotation and the rotation speed.

As shown in FIG. 8, six regions of the surface of the inner coating layer 21 are irradiated with the laser beams 38 from the laser oscillator 31 in a way similar to that of the first embodiment.

For example, the piston base member 1a is moved upward to a predetermined level by the elevator 40, and then is rotated to have a predetermined rotation angle. Under this condition, the upper left region 21c is irradiated with the laser beams 38 from the laser oscillator 31 with a predetermined laser output for a predetermined period of time. Then, the piston base member 1a is rotated by the stepping motor 36 in the clockwise direction of the arrow in FIG. 12 to have a predetermined rotation angle. Under this condition, the upper center region 21b is irradiated with the laser beams 38 with a predetermined laser output for a predetermined period of time. Then, the piston base member 1a is further rotated by the stepping motor 36 in the clockwise direction in FIG. 12 to have a predetermined rotation angle. Under this condition, the upper right region 21a is irradiated with the laser beams 38 with a predetermined laser output for a predetermined period of time.

Then, the piston base member 1a is moved upward to a predetermined level. Under this condition, the lower right region 21a′ is irradiated with the laser beams 38 with a predetermined laser output for a predetermined period of time. Then, the piston base member 1a is rotated by the stepping motor 36 in the counterclockwise direction to have a predetermined rotation angle. Under this condition, the lower center region 21b′ is irradiated with the laser beams 38 with a predetermined laser output for a predetermined period of time. Then, the piston base member 1a is rotated by the stepping motor 36 in the counterclockwise direction to have a predetermined rotation angle. Under this condition, the lower left region 21c′ is irradiated with the laser beams 38 with a predetermined laser output for a predetermined period of time.

With this, the energy density becomes uniform on the inner coating layer 21 in its entirety, similar to the first and second embodiments. In other words, it is possible to uniformly heat and dry the inner coating layer 21 as a whole.

As a result, it is possible to obtain advantageous effects similar to those of the first and second embodiments. In particular, it is possible in the third embodiment to more greatly reduce the facility cost due to the use of only a single laser oscillator, as compared with the first and second embodiments.

It is also possible to change the laser output of the laser oscillator 31, depending on the rotation angle and the position in the vertical direction, by continuously rotating the piston base member 1a and continuously moving the same in the vertical direction by the stepping motor 36 and the elevator 40.

The present invention is not limited to the above-mentioned embodiments. The solid lubricant coating film is not limited to a double-layered one, but may be a single-layered one. Alternatively, it may have more than two layers.

The use of the solid lubricant coating film of the present invention is not limited to the piston 1 of the internal combustion engine. The coating film is fit for a wide range of uses in sliding members under oil lubrication conditions and under dry lubrication conditions. Although an aluminum alloy is used as the piston base member 1a in the above embodiments, there can be used any other base materials, such as cast iron, steel and copper alloy, in place of aluminum alloy, in view of the fact that the binder resin (polyamide-imide resin, polyimide resin, and/or epoxy resin) of the double-layer coating film is superior in adhesion to the piston base member 1a. Among others, the coating film is suitable for application to the piston 1 of the internal combustion engine, particularly thrust-side and counterthrust-side skirt portions 8, 9 of the piston 1 as explained above.

The solid lubricant contained in the coating film is not limited to black-color components (e.g., graphite, carbon black, and molybdenum disulfur), but it suffices that the coating film contains a dark-color component capable of absorbing heat of laser beams.

For example, it is also possible to contain a dark-color component, such as boron nitride, a metal powder of iron alloy, or a metal powder of aluminum alloy.

The color of the solid lubricant coating film is not limited to black. For example, it may have a gray color or green color, as long as a component contained therein has a black color or a dark color to generate heat by absorbing the laser beams.

In the above embodiments, the piston base member 1a is rotated or moved in the vertical direction during the laser beam irradiation. Alternatively, it is possible to irradiate the piston base member 1a with the laser beams by rotating or moving the laser oscillator(s) in the vertical direction by an industrial robot, while not moving the piston base member 1a. Alternatively, it is possible to irradiate the piston base member 1a with the laser beams by rotating or moving the piston base member 1a in the vertical direction, while not moving the laser oscillator(s).

What is claimed is:

1. A method for forming a double-layer, solid lubricant coating film on an external surface of a skirt portion of a piston in an internal combustion engine, comprising the steps of:
(a) applying on the external surface of the skirt portion a solid lubricant composition containing a dark-color component, thereby forming thereon a precursor film; and
(b) solidifying the precursor film by an irradiation with a laser beam from a laser oscillator, while moving at least one of the piston and the laser oscillator.

2. The method according to claim 1, wherein the step (b) is a drying or baking treatment of the precursor film.

3. The method according to claim 1, wherein the step (b) is conducted, while the laser oscillator is fixed at a position, and the piston is moved relative to the laser oscillator.

4. The method according to claim 3, wherein the step (b) is conducted, while the piston is rotated about an axis of the piston.

5. The method according to claim 4, wherein the laser oscillator comprises upper and lower laser oscillator units aligned in a direction along the axis of the piston, and wherein the piston is rotated about the axis of the piston under a condition an energy density of the laser beam from the upper laser oscillator unit on a crown-side portion of the piston is made to be greater than an energy density of the laser beam from the lower laser oscillator unit on a crankshaft-side portion of the piston.

6. The method according to claim 5, wherein a period of time for irradiating the crown-side portion of the piston is longer than that for irradiating the crankshaft-side portion of the piston.

7. The method according to claim 3, wherein the step (b) is conducted, while the piston is moved in a direction along an axis of the piston.

8. The method according to claim 7, wherein the laser oscillator comprises a plurality of laser oscillator units aligned in a circumferential direction of the piston, and wherein the piston is moved in the direction along the axis of the piston under a condition an energy density of the laser beam on both side portions of the piston in the circumferential direction of the piston is greater than a center portion of the piston in the circumferential direction of the piston.

9. The method according to claim 8, wherein a period of time for irradiating the both side portions of the piston is longer than that for irradiating the center portion of the piston.

10. The method according to claim 3, wherein the step (b) is conducted, while rotating the piston about an axis of the piston and moving the piston in a direction of the axis of the piston.

11. The method according to claim 10, wherein the step (b) is conducted, while rotating the piston in a first direction about the axis of the piston, then moving the piston in a direction along the axis of the piston, and then rotating the piston in a second direction opposite to the first direction.

12. The method according to claim 2, wherein the step (b) is conducted, while the piston is fixed at a position, and the laser oscillator is moved relative to the piston.

13. The method according to claim 2, wherein the dark-color component is at least one selected from the group consisting of graphite, carbon black, and molybdenum disulfur.

14. The method according to claim 13, wherein a content by weight percentage of the dark-color component is such that the following inequality (1) is satisfied,
12 wt %≦(G+B+0.46×M)≦50 wt % (1)
wherein G represents a content by weight percentage of the graphite, B represents a content by weight percentage of the carbon black, and M represents a content by weight percentage of the molybdenum disulfur.

15. A method for forming a double-layer, solid lubricant coating film on an external surface of a skirt portion of a piston in an internal combustion engine, the double-layer, solid lubricant coating film comprising an inner solid lubricant layer and an outermost solid lubricant layer, the method comprising the steps of:
(a) applying on the external surface of the skirt portion a solid lubricant composition containing a black-color component, thereby forming thereon a precursor film of the inner solid lubricant layer;
(b) irradiating the precursor film with a laser beam from a laser oscillator, while moving at least one of the piston and the laser oscillator, thereby conducting a drying or baking treatment on the precursor film to produce the inner solid lubricant layer;
(c) applying on the inner solid lubricant layer a solid lubricant composition, thereby forming thereon a precursor film of the outermost solid lubricant layer; and
(d) drying the precursor film of the outermost solid lubricant layer by a laser irradiation or a baking treatment in a furnace to produce the outermost solid lubricant layer.

16. The method according to claim 15, wherein the laser oscillator comprises a plurality of laser oscillator units such that an energy density on a crown-side portion of the piston is greater than that on a crankshaft-side portion of the piston or that energy density on both side portions of the piston in a circumferential direction of the piston is greater than that on a center portion of the piston in the circumferential direction of the piston.

17. An apparatus for forming a double-layer, solid lubricant coating film on an external surface of a skirt portion of a piston in an internal combustion engine, the double-layer solid lubricant coating film comprising an inner solid lubricant layer, the apparatus comprising:
a mechanism for applying on the external surface of the skirt portion a solid lubricant composition containing at least one selected from the group consisting of graphite, carbon black, molybdenum disulfur, boron nitride, and a metal powder, thereby preparing a precursor film of the inner solid lubricant layer;
a laser oscillator for irradiating the precursor film with a laser beam to dry the precursor film into the inner solid lubricant layer; and
a mechanism for moving at least one of the piston and the laser oscillator, while irradiating the precursor film with the laser beam.
